(19) United States
(12) Patent Application Publication
(10) Pub. No.: US 2017/0297586 A1
(43) Pub. Date: Oct. 19, 2017

(54) SYSTEM AND METHOD FOR DRIVER PREFERENCES FOR AUTONOMOUS VEHICLES

(71) Applicant: TOYOTA MOTOR ENGINEERING & MANUFACTURING NORTH AMERICA, INC., Erlanger, KY (US)

(72) Inventor: Yi LI, Ann Arbor, MI (US)

(73) Assignee: TOYOTA MOTOR ENGINEERING & MANUFACTURING NORTH AMERICA, INC., Erlanger, KY (US)

(21) Appl. No.: 15/097,906

(22) Filed: Apr. 13, 2016

(51) Int. Cl. B60W 50/08; G05D 1/00

(52) U.S. Cl. CPC B60W 50/08; G05D 1/0088

(57) ABSTRACT

The driver preferences system can determine driver habits and preferences based on output from a plurality of sensors. Utilizing the output from the plurality of sensors, an autonomous vehicle can operate according to the learning habits and preferences of the driver. The operator of the driver preferences system can finely adjust any habits or preferences via a driver preferences interface, as well as select preset modes including an aggressive driving mode or a cautious driving mode. Additionally, one or more driver profiles can be stored and selected via the driver preferences interface so that more than one driver can have an autonomous vehicle operator according to their personal driving habits and/or preferences.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Even with strict laws governing the operation of vehicles, each driver can have driving preferences as unique as their own personality. Each driver's habits/preferences can have been taught as they learned to drive, as well as developed over time as each driver grows into their own driving style. As long as the habits/preferences are within the law (and even times when they are not), there is no limit on each driver's habits or preferences as they operate a vehicle.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

Embodiments of the disclosed subject matter relate generally to systems, apparatuses, and methods for recognizing one or more driving habits of a driver over a predetermined duration of time and an autonomous vehicle (wherein the autonomous vehicle is a vehicle capable of a manual driving mode and an autonomous driving mode) can make driving decisions based on the driver's driving habits as recognized by the system. The autonomous vehicle can then be more tailored to the driver's personal driving style.

The autonomous vehicle can construct predefined settings of driving behavior based on a sample of the driver's driving style over a predetermined period of time (e.g., two days). The autonomous vehicle can then, when driving autonomously, adapt its driving style based on the predefined settings. For example, the predefined settings may indicate that the driver does not like to drive in the left lane. As such, the autonomous vehicle may try to adapt its driving behavior to avoid the left lane. In other words, the autonomous vehicle can determine the driver's habits/preferences and drive the vehicle like the driver would drive the vehicle in a manual mode. The autonomous vehicle can learn the driving behavior of the driver while the driver is driving in the manual driving mode and mimic the driver's behavior to improve the driver's comfort while the vehicle is in an autonomous mode, performing as the driver does when the driver is controlling the vehicle in the manual mode.

In addition to the learning time, the driver can manually adjust the settings to more closely match the preferences of the driver. The adjustments can be more precise on a fine scale. For example, where the system may make an adjustment when determining a driver's preferences, the driver may then manually fine tune the automatic adjustment via a driver preferences interface.

To set the driver's habits/preferences, the system may utilize a look up table. For example, if the driver is driving at 45 MPH in a 50 MPH zone, a lookup table can be utilized to indicate, for example, that the driver may prefer to drive 5 miles per hour under the speed limit or 10% under the speed limit. Thus, when the autonomous vehicle drives in a 30 MPH zone, it will either drive at 25 MPH (when utilizing the 5 mile per hour under rule in the lookup table) or drive at 27 MPH (utilizing the 10% Wile in the lookup table).

Additionally, a statistical model may be utilized. For example, an average driving speed could be taken over a predetermined amount of time and set as the driver's preferred driving speed.

Further, machine learning can be utilized to learn the driver's habits/preferences and perform a prediction of the driver's habits/preferences in real-time. For example, the driver's behavior can be collected and analyzed over time and used in conjunction with historical information from previous learning time (stored in a database, for example). The prediction can be based off of the driver's behavior and the historical information to make a prediction (e.g., when a driver wants to speed up the vehicle).

It should be appreciated that the look-up table, statistical models, and machine learning can be utilized independently or in combination to determine and implement the driver's driving habits/preferences.

Several different habits/preferences can be determined and set by the system including vehicle speed, acceleration of the vehicle, handling turns (sharpness, speed, etc.), deceleration of vehicle, changing lanes, merging lanes, and the like.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts a block diagram of a driver preferences system according to one or more embodiments of the disclosed subject matter.

FIG. 2 depicts a block diagram of a plurality of sensors in the driver preferences system according to one or more embodiments of the disclosed subject matter.

FIG. 3 depicts an exemplary view of a driver preferences interface according to one or more embodiments of the disclosed subject matter.

FIG. 4 depicts an exemplary view of an adjust preferences interface according to one or more embodiments of the disclosed subject matter.

FIG. 5 depicts an exemplary control system of the driver preferences system according to one or more embodiments of the disclosed subject matter.

FIG. 6 is a flow chart of a method for determining and implementing driver preferences.

FIG. 7 is a flow chart of a method for implementing driver preferences using a lookup table and statistical models.

FIG. 8 is a flow chart of a method for implementing driver preferences using machine learning algorithms.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views.

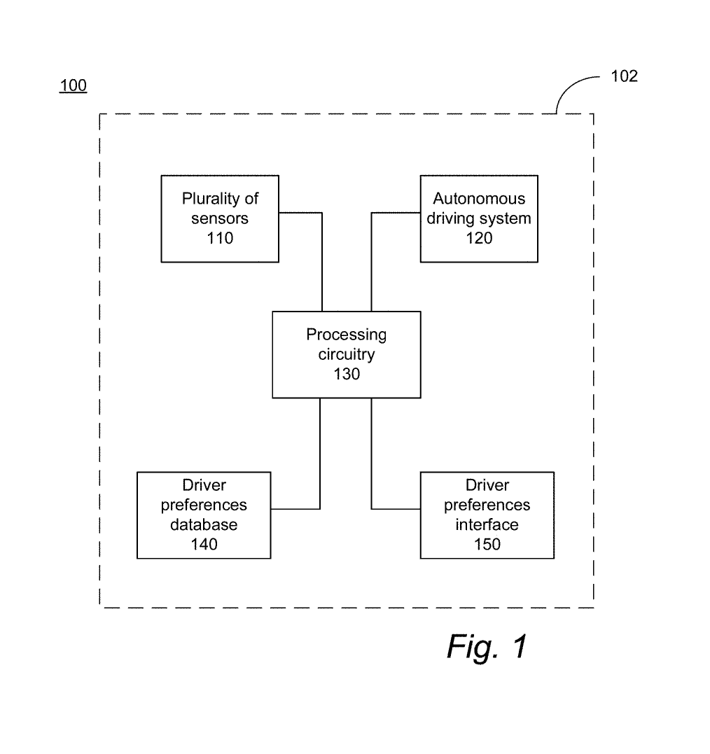

FIG. 1 is a block diagram of a driver preferences system 100 (herein referred to as the system 100) according to one or more embodiments of the disclosed subject matter. As will be discussed in more detail later, one or more methods according to various embodiments of the disclosed subject matter can be implemented using the system 100 or portions thereof. Put another way, system 100, or portions thereof, can perform the functions or operations described herein regarding the various methods or portions thereof (including those implemented using a non-transitory computer-readable medium storing a program that, when executed, configures or causes a computer to perform or cause performance of the described method(s) or portions thereof).

System 100 can comprise a plurality of sensors 110, an autonomous driving system 120, a processor or processing circuitry 130 (which can include internal and/or external memory), a driver preferences database 140, and a driver preferences interface 150. In one or more embodiments, the plurality of sensors 110, autonomous driving system 120, the processing circuitry 130, the driver preferences database 140, and the driver preferences interface 150 can be implemented in apparatus 102, such as a vehicle, for instance, wherein the vehicle is capable of driving in a manual mode (i.e., operated manually by a driver) and an autonomous mode (i.e., operated autonomously by the autonomous driving system 120). Further, the aforementioned components can be electrically connected or in electrical or electronic communication with each other as diagrammatically represented by FIG. 1, for example.

Generally speaking, system 100 can cause or allow a vehicle to determine preferences associated with the driver of the vehicle and implement the preferences when the vehicle is in the autonomous driving mode.

More specifically, based on various received signals (e.g., from the plurality of sensors 110), the system 100 can recognize and store driver preferences such as position within a driving lane, acceleration/deceleration of the vehicle, speed at which a turn is executed, etc. The habits/preferences can then be implemented in the autonomous driving mode to mimic the driver's habits/preferences as closely as possible.

The plurality of sensors 110 can include various sensors to operate an autonomous vehicle as further described herein. The types of sensors 110 can include a LIDAR sensor, a Radar sensor, a laser scanner, at least one camera, an odometer, a GPS antenna, Sonar and the like. The same sensors used to operate the vehicle in the autonomous mode can be utilized in a learning mode. In the learning mode, which can be a predetermined amount of time of the driver driving in the manual mode, the information received from the plurality of sensors 110 can be analyzed by the processing circuitry 130 (stored in a look-up table, included in a statistical model, utilized by machine learning, etc.) to determine driver preferences. For example, the driver may prefer to drive shifted by 8 inches to the right relative to the center of the driving lane. This preference may be recognized via the plurality of sensors 110 while in the learning mode as the driver will drive by habit/preference off-center in the driving lane. The preference can then be stored in memory to be implemented when the vehicle is in the autonomous mode. Similarly, any recognized habit/preference of the driver during the learning mode can be implemented in the autonomous mode.

It should be appreciated that any sensor can be included in the plurality of sensors 110 such that the sensor may improve the safety and/or the precision with which an autonomous vehicle operates as would be known by one or ordinary skill in the art.

The autonomous driving system 120 can include various mechanisms to mechanically operate an autonomous vehicle. For example, the mechanisms can include a motor in each wheel to rotate the wheel, an actuator to automatically operate the steering wheel, one or more mechanisms to cause the vehicle to accelerate, decelerate via a braking mechanism disposed in the vehicle, and the like, as well as any mechanisms that are required to operate a vehicle in general whether or not they are specifically operated by the autonomous mode. Therefore the autonomous vehicle system 120 can operate the autonomous vehicle mechanically and in response to signals received from the processing circuitry 130 as would be known by one or ordinary skill in the art.

The processor or processing circuitry 130 can carry out instructions to perform or cause performance of various functions, operations, steps or processes of the system 100. The processor/processing circuitry 130 can be configured to store information in memory, operate the system 100, control the autonomous driving system 120, store/access data in the driver preferences database 140, and display and receive signals from the driver preferences interface 150.

The driver preferences interface 150 can display various information to the driver relating to the driver's preferences, begin/end the learning mode, manual mode, and autonomous mode, finely adjust driver preferences, and the like as further described herein.

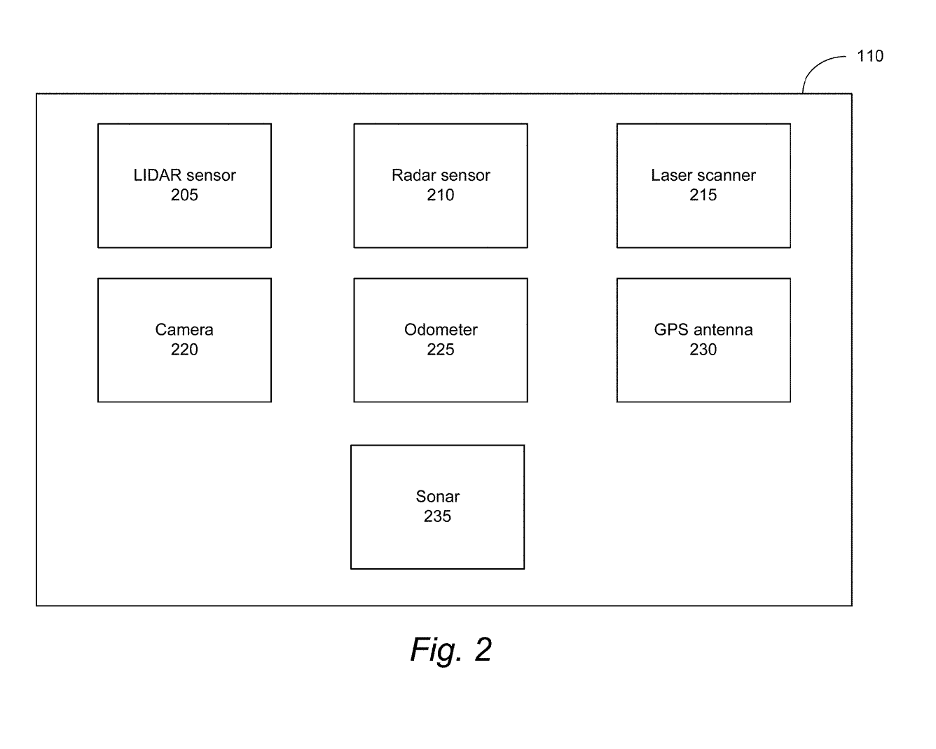

FIG. 2 is a block diagram of the plurality of sensors 110. The plurality of sensors 110 can include a LIDAR sensor 205, a radar sensor 210, a laser scanner 215, a camera 220, an odometer 225, a GPS antenna 230, and Sonar 235. The plurality of sensors 110 can assist in autonomous operation of an autonomous vehicle as would be known by a person of ordinary skill in the art. It should be appreciated that one or more of each the plurality of sensors 110 as described herein can be disposed within or on the autonomous vehicle. Additionally, the sensors described herein are not intended to be limiting as more and different sensors may further improve the operation of the autonomous vehicle.

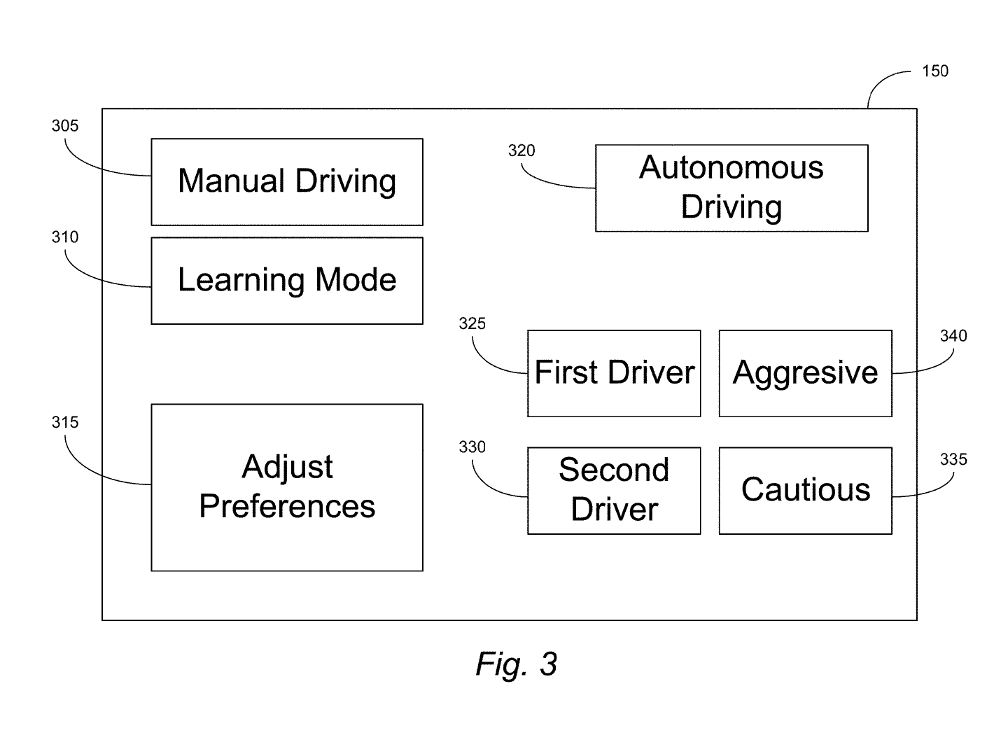

FIG. 3 depicts the driver preferences interface 150 according to one or more embodiments of the disclosed subject matter. The driver preferences interface 150 can be a touch screen LCD, for example, such that the driver may interact with the display and select predetermined portions of the display to transmit an associated signal to the processing circuitry 130 as would be known by one of ordinary skill in the art. The selectable portions of the driver preferences interface 150 can include manual driving 305, learning mode 310, adjust preferences 315, autonomous driving 320, first driver 325, second driver 330, aggressive 340, and cautious 335.

The manual driving 305 can activate the manual driving mode where the vehicle can be driven manually by the driver. However, this may be separate from the learning mode 310 because, although the learning mode is also a mode where the driver manually drives the vehicle, the learning mode includes receiving output from the plurality of sensors 110. It may be important to separate the manual driving 305 and the learning mode 310 to allow more than one driver to have predetermined settings. For example, if the learning mode 310 was the only option, anytime a different driver drove the vehicle manually, the preferences associated with that driver will be recognized and the habits/preferences will be adjusted accordingly even though the habits/preferences may differ from other drivers driving the vehicle. Therefore, it may be advantageous to have a separate manual driving 305 and learning mode 310 in a situation where the driver does not want habits/preferences to be monitored at that time.

With respect to predetermined driver preferences, upon selection of autonomous driving 320, the vehicle, as a part of the system 100, can drive autonomously while implementing the driver's habits/preferences as determined by the learning mode 310. To further customize the autonomous driving mode, the driver preferences interface 150 can include first driver 325, second driver 330, aggressive 340, and cautious 345.

The first driver 325 and the second driver 330 (driver profiles) can be selected to implement habits/preferences associated with a specific driver. For example, the driver associated with the first driver 325 may be the main driver of the vehicle, as in they drive the vehicle a majority of the time. The driver may select first driver 325 via the driver preferences interface 150 and then select learning mode 310 or autonomous driving 320, for example. The learning mode 310 can then associate all the determined habits/preferences with the first driver 325 and the autonomous driving 320 can drive autonomously while implementing the habits/preferences associated with the first driver 325. Similarly, the second driver 330, or any third, fourth, fifth, etc. driver for which the system 100 can be configured to include, can utilize the learning mode 310 and autonomous driving 320 with habits/preferences specifically associated with the driver currently driving/operating the vehicle.

The first driver 325 may be automatically selected when the driver selects autonomous driving 325. However, the driver preferences interface 150 may also be configured to have the driver selection be independent from the selection of autonomous driving 320. Additionally, should the driver profile be selected prior to the selection of autonomous driving 320, the driver preferences interface 150 can activate the autonomous driving mode implementing the previously selected driver profile. Additionally, the correct driver profile can be selected via one or more cameras, such as camera 220, using facial recognition software.

The aggressive 340 and cautious 335 modes can also be selected to be implemented in combination with the autonomous driving 320. The aggressive 340 and cautious 335 modes may implement aggressive driving preferences and cautious driving preferences, respectively. For example, if the preferences associated with the first driver 325 may accelerate from 30 MPH to 60 MPH in 10 seconds, the aggressive driving mode (aggressive 340) may accelerate from 30 MPH to 60 MPH in 5 seconds. Alternatively, the cautious driving mode (cautious 335) may accelerate from 30 MPH to 60 MPH in 15 seconds. Aggressive 340 and cautious 335 can automatically adjust any suitable driver preference that would cause the system 100 to operate more aggressively or cautiously, respectively. The aggressive 340 and cautious 335 preferences may have been determined in the learning mode 310 via output from the plurality of sensors 110 being more aggressive and more cautious than an average as determined by processing circuitry 130. Alternatively, the aggressive or cautious preferences may be extrapolated from the output received from the plurality of sensors 110, such as 5% more or less, respectively, from an average as determined by the processing circuitry 130. Aggressive and/or cautious are simply terms that can be used to describe a driving style preference and may not define extremes on either end, but simply a predetermined amount more or less than the average as determined by the processing circuity. Any suitable term could be used in its place.

The adjust preferences section 315 of the driver preferences interface 150 can finely adjust driver preferences as further described herein.

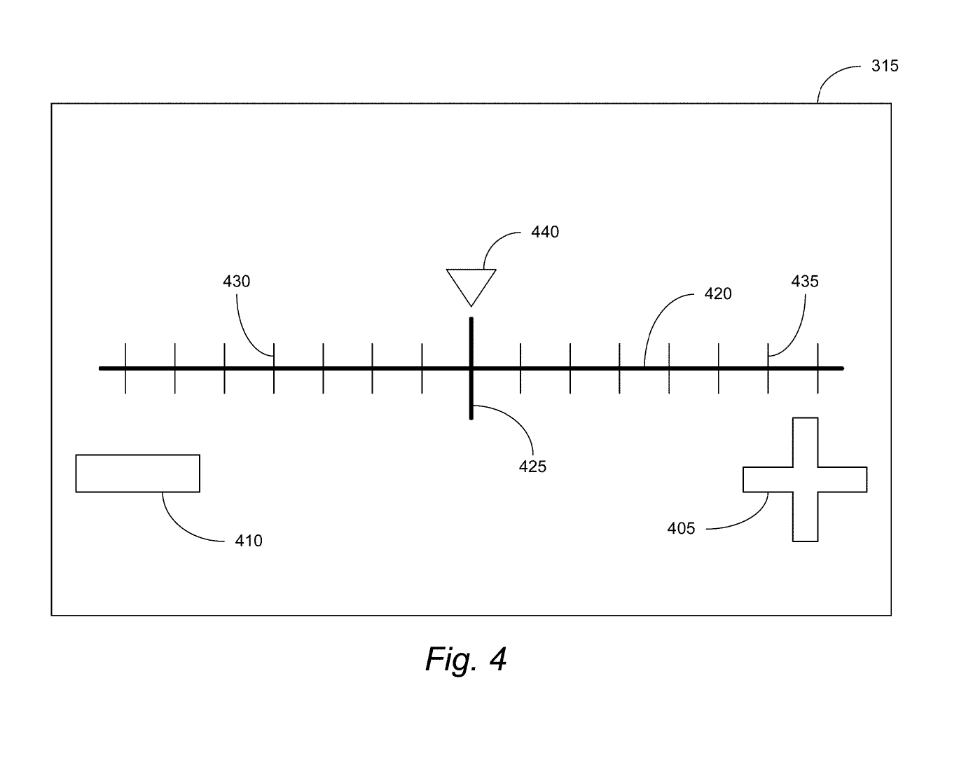

The adjust preferences section 315 may be interacted with in a predetermined subsection of the driver preferences interface 150 as illustrated in FIG. 3. Optionally, or additionally, the adjust preferences section 315 can open a separate enlarged view on the driver preferences interface 150 that may encompass the entire display as illustrated in FIG. 4.

FIG. 4 depicts an exemplary view of the adjust preferences section 315 of the driver preferences interface 150. The adjust preferences section 315 can include a number line 420, a zero-point 425, a plurality of right-side indicators 435, a plurality of left-side indicators 430, an adjustment indicator 440, an increase button 405, and a decrease button 410.

The zero-point 425 can be associated with the currently set preference that the driver can finely adjust. For example, as a result of the learning mode 305, the vehicle, when in autonomous mode, may be driving shifted 7 inches to the right of the center of the driving lane. The driver may then shift further to the right (via the increase button 405) to 8 inches right of center, for example, or shift to the left (via the decrease button 410) to 6 inches right of center, for example. The adjustment can be indicated via the adjustment indicator 440 which can point to the hash mark (one of right side indicators 435 or left side indicators 430) associated with the adjustment, for example. The new preference as adjusted may be implemented immediately, as well as stored and implemented the next time the driver selects autonomous driving 320 as shown in FIG. 3. Upon exiting the adjust preferences section 315, the zero-point will be displayed as the most recently adjust preference. For example, if the driver adjusted from 7 inches right of center (the previous zero-point 425) to 8 inches right of center, the zero-point 425 the next time the driver opened the adjust preferences section 315 would be 8 inches right of center. Additionally, the increase button 405 and the decrease button 410 can also be implemented by any mechanism suitable to adjust the preferences such as a rotatable dial, voice activation, buttons on a steering wheel, and the like.

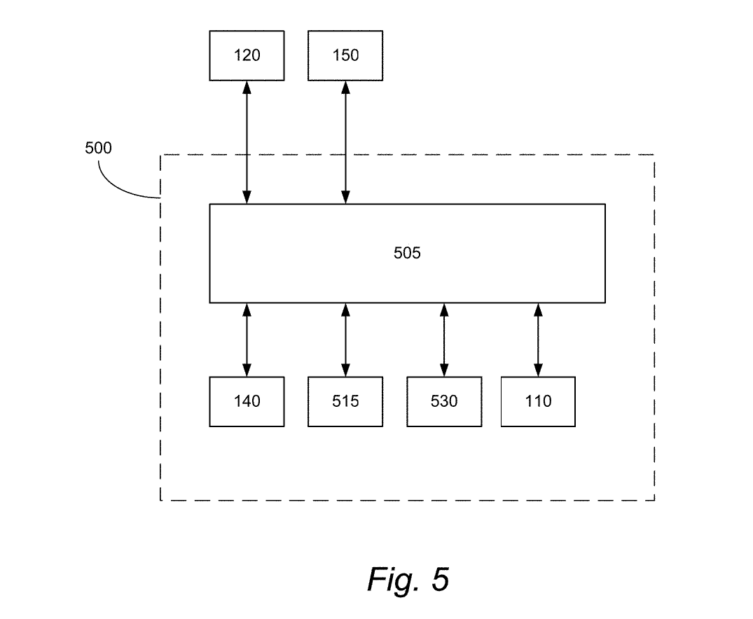

FIG. 5 depicts control aspects of a system 500 according to one or more embodiments of the disclosed subject matter. Optionally, system 500 can represent control aspects (i.e., controlee components and controller components) of system 100 for FIG. 1.

In FIG. 5, the system 500 can include a control circuit 505, the plurality of sensors 110, the autonomous driving system 120, the driver preferences database 140, the driver preferences interface 150, a positioning system 515, and a wireless receiver/transmitter 530.

The control circuit 505, which may be representative of processor/processing circuitry 130, can be configured to perform or cause performance of multiple functions, including receiving, monitoring, recording, storing, indexing, processing, and/or communicating data. The control circuit 505 can be integrated as one or more components, including memory, a central processing unit (CPU), Input/Output (I/O) devices or any other components that may be used to run an application. The control circuit 505 can be programmed to execute a set of predetermined instructions. Various instructions including lookup tables, maps, and mathematical equations can be stored in memory, however, it should be appreciated that the storing or reading of such information can be accomplished with alternative types of computer-readable media including hard disks, floppy disks, optical media, CD-ROM, or other forms of RAM or ROM. Additionally, other circuitry including power supply circuitry, signal-conditioning circuitry, solenoid driver circuitry, and communication circuitry can be included in the control circuit 505. Further, it should be appreciated that the control circuit 505 can include multiple controllers wherein each controller is dedicated to perform one or more of the above mentioned functions.

The control circuit 505 can be communicably coupled to the plurality of sensors 110. Each of the sensors 110 can provide output signals indicative of parameters related to the environment of the stand-alone apparatus 102, such as the vehicle with autonomous driving capability as described herein, via the system 100. The plurality of sensors 110 can be located in various positions on the stand-alone apparatus 102 such that the sensors are able to allow the vehicle to operate autonomously and determine driver preferences. The control circuit 505 can receive signals from each of sensors 110.

Optionally, the control system 500 can include a positioning system 515 configured to determine the location of the system 100. In an embodiment, the positioning system 515 can be a satellite positioning system such as GPS. Alternatively, the positioning system 515 can be GPS utilized in combination with positioning determined by one or more of the plurality of sensors 110. The control circuit 505 is communicably coupled to the positioning system 515 to continuously or periodically track the location of the system 100. The control system 500 can be configured to wired and/or wirelessly receive signals through a communicably coupled receiver/transmitter 530. Wireless communication can be any suitable form of wireless communication including radio communication, a cellular network, or satellite-based communication.

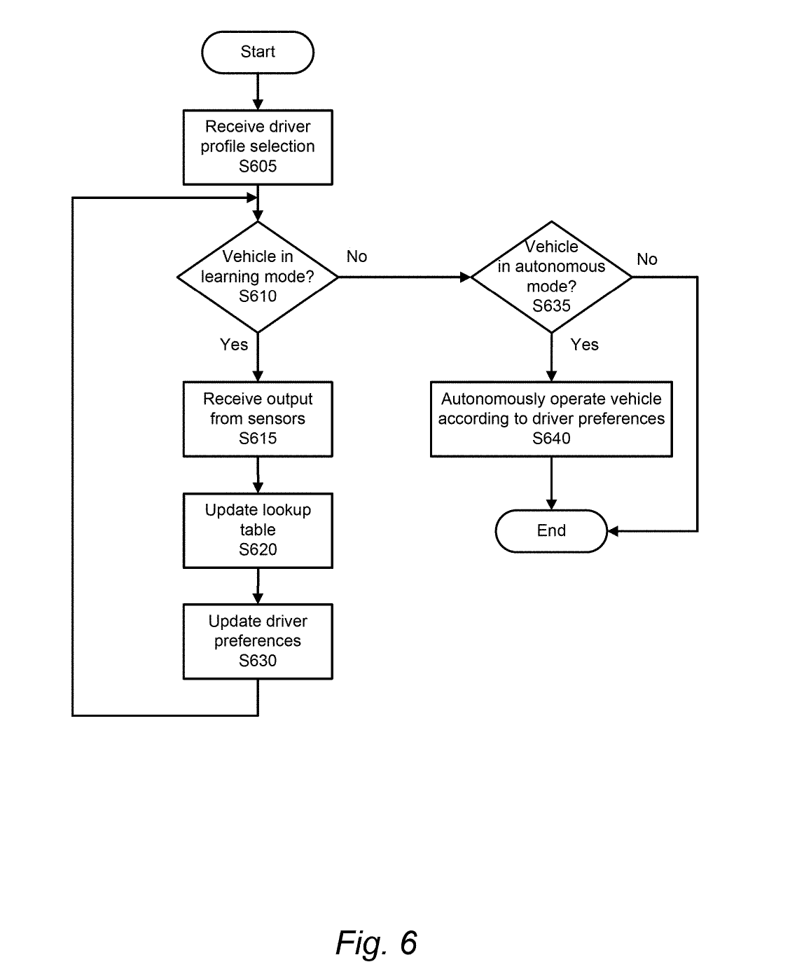

FIG. 6 depicts an exemplary flow chart of a method for causing the system 100 to determine driver preferences and implement the driver preferences in the autonomous driving mode.

In S605, a driver profile selection can be received. For example, the driver can select first driver 325 out of the available options of first driver 325 and second driver 330 to indicate that the current driver is the first driver 325 and all learned driver preferences and implemented driver preferences should be associated with the first driver 325. Additionally, the driver profile selection can be received automatically via image recognition from one or more of the plurality of sensors 110, such as the camera.

In S610 it can be determined if the vehicle is in the learning mode 310. If the vehicle is in the learning mode 310, then output can be received from the plurality of sensors 110 in S615.

In S615, output can be received from the plurality of sensors 110. The output received from the plurality of sensors 110 can be utilized to determine the driver preferences. The sensor output can be used to update the lookup table in S620.

In S630, the driver preferences can be updated based on the output received from the plurality of sensors 110 and the updates to the lookup table and the statistical models. The process of receiving output from the plurality of sensors 110 and updating the driver preferences can be continuous while in learning mode 310. Therefore, after the driver preferences are updated in S630, the process can return to S610 to determine if the vehicle is still in the learning mode 310.

In S610, if the vehicle is not in learning anode, then it can be determined if the vehicle is in the autonomous driving mode (via selection of autonomous driving 320) in S635.

In S635, it can be determined if the vehicle is in the autonomous driving mode via selection of autonomous driving 320 in the driver preferences interface 150. If the vehicle is not in autonomous driving mode, then the process can end as the vehicle is neither in learning mode or autonomous driving mode and therefore the vehicle can be in the manual mode via selection of manual driving 305 in the driver preferences interface 150. However, if the vehicle is in an autonomous driving mode, then the vehicle can be operated autonomously while implementing the most recently updated driver preferences via the system 100. After the vehicle is being operated autonomously while implementing the most recently updated driver preferences, the process can end. Additionally, it should be appreciated that operating the vehicle autonomously in S635 can include a selection of aggressive 340 or cautious 335, such that the selection can allow the vehicle to operate more aggressively or cautiously, respectively, as described in FIG. 3, based on the updated driver preferences in S630.

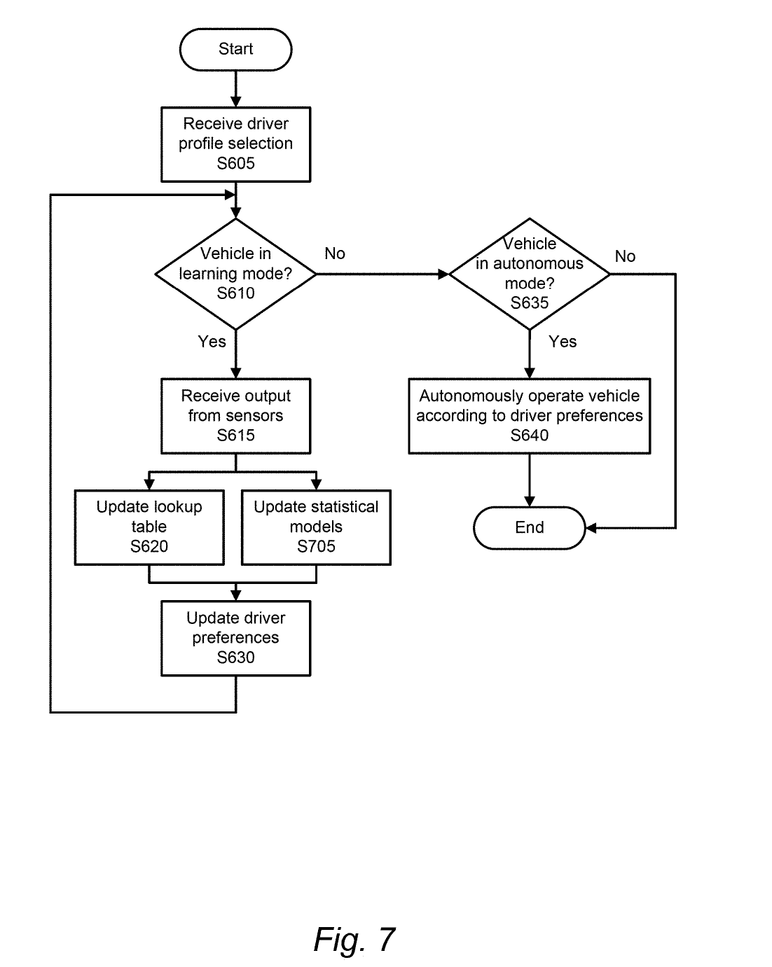

FIG. 7 is a flow chart of a method for implementing driver preferences using a lookup table and statistical models.

Steps S605, S610, S615, S620, S630, S635, and S640 can be the same as described in FIG. 6. The output received from the plurality of sensors 110 in S615 can be utilized to determine the driver preferences. The sensor output can be used to update the lookup table in S620 and update the statistical models in S705. The lookup table and the statistical models can be updated independently or in combination based on output received from the plurality of sensors 110.

Therefore, in S630, the driver preferences can be updated based on the output received from the plurality of sensors 110 and the updates to the lookup table in S620 and the statistical models in S705.

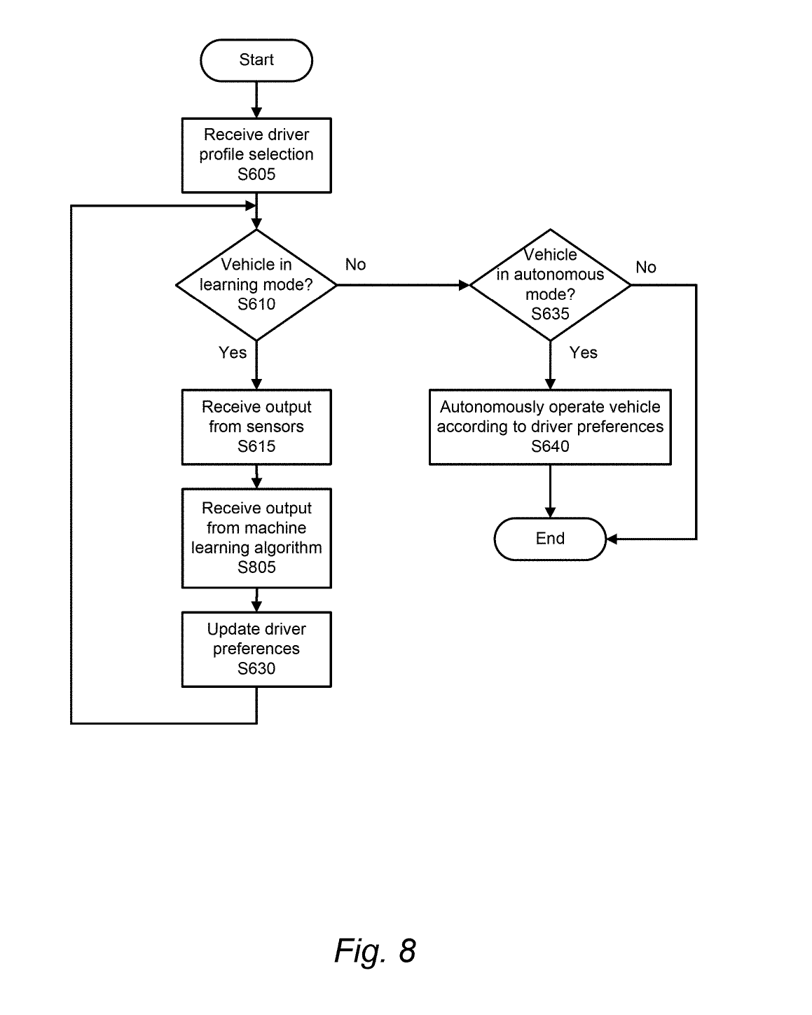

FIG. 8 is a flow chart of a method for implementing driver preferences using machine learning algorithms.

Steps S605, S610, S615, S630, S635, and S640 can be the same as described in FIG. 6. In S805, output can be received from a machine learning algorithm. Machine learning can handle a large amount of data using various techniques include support vector machine (SVM) which is efficient for smaller data samples, deep reinforcement learning which can be a training decision system, and recurrent neural network, particularly long-short term memory (LSTM), for sequential data. Utilizing the machine learning over time, the vehicle can learn the driver's habits/preferences and predict the driver's habits/preferences in real-time. For example, the driver's behavior can be collected, via the plurality of sensors 110 in S615, and analyzed over time. It should be appreciated that the output from machine learning can be used in conjunction with historical information including information from the lookup table, the statistical models, and the like. The prediction can be based off of the driver's behavior and the historical information stored in the lookup table and/or the statistical models (e.g., when a driver wants to speed up the vehicle).

Therefore, in S630 the driver preferences can be updated in real time based on the machine learning algorithm.

The system 100 can provide many advantages to the driver. For example, the system 100 can improve a driver's experience while riding in an autonomously operated vehicle. The driver may experience comfort in the familiar execution of driving maneuvers as if the driver was manually driving the autonomous vehicle. Further, the driver's habits, such as positioning in the driving lane, can provide additional comfort. Knowledge that the autonomous vehicle is driving as the driver would manually drive the vehicle can improve confidence in the autonomous driving mode as the driver knows how the autonomous driving mode will operate and handle various situations that arise while driving.

The adjust preferences section 315 can also be advantageous to the driver to provide an interface to finely adjust driver preferences. Such fine-tuned control over the driver's experience when the vehicle is in the autonomous driving mode allows the driver to fully customize the autonomous driving experience with extreme precision.

The further customization of the autonomous driving experience via the driver profiles (first driver 325 and second driver 330) can be advantageous for vehicles with multiple drivers such that a simple selection of the driver profile can associate all driver preferences with a specific driver. Additionally, the aggressive 340 and cautious 335 selections can allow the driver to quickly adjust their autonomous driving experience. For example, if the driver is late for work, the aggressive driving mode (via selection of aggressive 340) may allow the driver to arrive at their destination earlier.

It should be appreciated that any preferences and/or mode selected may be implemented to its fullest potential while still operating with various predetermined safety measures implemented by autonomous vehicles as would be understood by one of ordinary skill in the art. For example, although the aggressive driving mode may be selected, the autonomous vehicle, via the plurality of sensors 110, may prevent the vehicle from being involved in a collision with another vehicle, object, and the like. Similarly, should the vehicle detect, unsafe conditions, such as heavy rainfall, the driver preferences may be adjusted accordingly to maintain a predetermined level of safety.

Additionally, while in the learning mode 310, the plurality of sensors 110 may be utilized to determine an average vehicle speed for the statistical models, for example. However, average speed may be affected by traffic, unsafe conditions, weather, etc. Therefore, the plurality of sensors 110 may also determine that the vehicle is in traffic via one or more of the plurality of sensors 110 and not include the average speed from the time that the vehicle was in traffic in the statistical models when determining the driver's preferred average speed when driving in an area with a particular speed limit.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. An autonomous vehicle system comprising:
a plurality of sensors;
a driver preferences database;
a driver preferences interface; and
circuitry configured to
receive a driver profile selection, the selection having been selected via the driver preferences interface and previously stored in the driver preferences database,
determine whether the autonomous vehicle is in one of a learning mode, an autonomous mode, or a manual mode,
when the vehicle is in the learning mode, receive output from the plurality of sensors, set driver preferences in response to the output from the plurality of sensors and store the updated preferences in the driver preferences database,
autonomously operate the autonomous vehicle according to the driver preferences when the autonomous vehicle is in the autonomous mode, and
maintain the driver preferences unchanged when the vehicle is in the manual mode.

2. The autonomous vehicle system of claim 1, wherein the circuity is configured to
update a lookup table stored in the driver preferences database in response to receiving the output from the plurality of sensors, and
update one or more statistical models stored in the driver preferences database in response to receiving the output from the plurality of sensors.

3. The autonomous vehicle system of claim 1, wherein the plurality of sensors includes a LIDAR sensor, a radar sensor, a laser scanner, at least one camera, an odometer, and a GPS antenna.

4. The autonomous vehicle system of claim 2, wherein the driver preferences interface includes selections for a manual driving mode, the learning mode, an autonomous driving mode, a plurality of driver profiles, an aggressive driving mode, a cautious driving mode, and an adjust-preferences section.

5. The autonomous vehicle system of claim 4, wherein each of the plurality of driver profiles includes driver preferences associated with each profile stored in the driver preferences database.

6. The autonomous vehicle system of claim 2, wherein the autonomous driving mode implements driver preferences utilizing the lookup table and the statistical models.

7. The autonomous vehicle system of claim 4, wherein the aggressive driving mode implements the driver preferences at a predetermined level above the autonomous driving mode preferences based on the lookup table and the statistical models.

8. The autonomous vehicle system of claim 4, wherein the cautious driving mode implements the driver preferences at a predetermined level below the autonomous driving mode preferences.

9. The autonomous vehicle system of claim 4, wherein the adjust preferences section allows the user to finely adjust the driver preferences via the driver preferences interface.

10. The autonomous vehicle system of claim 4, wherein the manual mode is driving manually without receiving input from the plurality of sensors specifically for determining driver preferences.

11. The autonomous vehicle system of claim 4, wherein the learning mode is driving manually while receiving input from the plurality of sensors specifically for determining driver preferences.

12. The autonomous vehicle system of claim 1, wherein the driver profile selection is received automatically via at least one camera through facial recognition.

13. The autonomous vehicle system of claim 2, wherein a preferred average vehicle speed in a predetermined area as recorded by the plurality of sensors is not included in the updated look-up table or the updated statistical models when the plurality of sensors determine that the vehicle is in vehicle traffic.

14. The autonomous vehicle system of claim 2, wherein the driver preferences are predicted in real-time via machine learning such that the driver preferences are collected and analyzed over time and used in combination with historical information stored in the driver preferences database.

15. A method of operating an autonomous vehicle system comprising:
receiving a driver profile selection, the selection having been selected via a driver preferences interface and previously stored in a driver preferences database;
determining, via processing circuitry, if the autonomous vehicle is in one of a learning mode, an autonomous mode, or a manual mode;
when the vehicle is in the learning mode, receiving output from a plurality of sensors setting driver preferences in response to the output from the plurality of sensors and store the updated preferences in the driver preferences database;
autonomously operating an autonomous vehicle via the autonomous vehicle system according to the driver preferences when the autonomous vehicle system is in the autonomous mode; and
maintaining the driver preferences unchanged when the vehicle is in the manual mode.

16. The method of claim 15, further comprising:
updating a lookup table stored in the driver preferences database in response to receiving the output from the plurality of sensors; and
updating one or more statistical models stored in the driver preferences database in response to receiving the output from the plurality of sensors.

17. A non-transitory computer-readable storage medium storing computer-readable instructions that, when executed by a computer cause the computer to perform a method comprising:
receiving a driver profile selection, the selection having been selected via a driver preferences interface and previously stored in a driver preferences database;
determining if the autonomous vehicle is in one of a learning mode, an autonomous mode, or a manual mode;
when the vehicle is in the learning mode, receiving output from a plurality of sensors, setting driver preferences in response to the output from the plurality of sensors and store the updated preferences in the driver preferences database;
autonomously operating an autonomous vehicle via the autonomous vehicle system according to the driver preferences when the autonomous vehicle system is in the autonomous mode; and
maintaining the driver preferences unchanged when the vehicle is in the manual mode.

18. The non-transitory computer-readable storage medium of claim 17, further comprising:
updating a lookup table stored in the driver preferences database in response to receiving the output from the plurality of sensors; and
updating one or more statistical models stored in the driver preferences database in response to receiving the output from the plurality of sensors.
